(19) United States
(12) Patent Application Publication
(10) Pub. No.: US 2025/0155644 A1
(43) Pub. Date: May 15, 2025

(54) OPTICAL CONNECTION STRUCTURE, OPTICAL MODULE, AND METHOD FOR MANUFACTURING OPTICAL MODULE

(71) Applicant: SUMITOMO ELECTRIC INDUSTRIES, LTD., Osaka (JP)

(72) Inventor: Kunio KOBAYASHI, Osaka-shi (JP)

(73) Assignee: SUMITOMO ELECTRIC INDUSTRIES, LTD., Osaka (JP)

(21) Appl. No.: 18/939,014

(22) Filed: Nov. 6, 2024

(30) Foreign Application Priority Data
Nov. 9, 2023 (JP) 2023-191443

(51) Int. Cl. G02B 6/30

(52) U.S. Cl. CPC G02B 6/30

(57) ABSTRACT

An optical connection structure according to one embodiment includes an optical element including a substrate, and a first optical waveguide formed on the substrate and extending in a first direction; and an optical fiber including a second optical waveguide extending in the first direction. The optical element has a connecting surface intersecting the first direction. The connecting surface includes, in a plan view of the substrate, a first recess recessed in the first direction, and a second recess further recessed in the first direction inside the first recess. The optical fiber is inserted into the first recess, and is connected to the optical element. The second optical waveguide is optically connected to the first optical waveguide in the second recess.

### CROSS-REFERENCE TO RELATED APPLICATION

This application claims priority from Japanese Patent Application No. 2023-191443, filed on Nov. 9, 2023, the entire subject matter of which is incorporated herein by reference.

### TECHNICAL FIELD

The present disclosure relates to an optical connection structure, an optical module, and a method for manufacturing an optical module.

### BACKGROUND OF THE INVENTION

International Publication WO 2022/102053 describes an optical connection structure including an optical waveguide element; an optical fiber; and a connecting portion that optically connects the optical waveguide element and the optical fiber to each other. The optical waveguide element is a silicon photonics (SiPh) element. The optical waveguide element includes a Si substrate; a buried oxide (BOX) layer provided on the Si substrate; a Si waveguide provided on the BOX layer; and an overcladding provided on the Si waveguide. A V-groove is formed on the Si substrate. The optical fiber is disposed in the V-groove formed on the Si substrate. The optical fiber is disposed such that an end face of the optical fiber faces an end face of the optical waveguide element. A signal light is emitted from the optical fiber, and the signal light is incident on the Si waveguide.

The connecting portion includes a self-written waveguide formed between the optical waveguide element and the optical fiber, and a cladding that covers the self-written waveguide. In the self-written waveguide, a portion of which the refractive index changes due to light irradiation serves as a core. The cladding is a refractive index matching material applied between the optical fiber and the optical waveguide element. The optical waveguide element has an inclined surface facing the end face of the optical fiber. In a cross section along an optical axis of the optical fiber, the inclined surface is inclined with respect to the end face of the optical fiber to approach a bottom of the V-groove as the inclined surface becomes more spaced apart from the Si waveguide. The self-written waveguide is formed between the inclined surface and the end face of the optical fiber.

Japanese Unexamined Patent Publication No. 2020-106678 describes an optical module and a method for manufacturing the same. The optical module includes a semiconductor chip; an optical fiber; and a support member that supports the optical fiber. The semiconductor chip includes an optical waveguide and an optical element on a silicon substrate. The silicon substrate has a rectangular plate shape. The silicon substrate has a side surface on which an input/output portion of the optical waveguide is formed. Optical semiconductor chips are cut from a semiconductor wafer using stealth dicing technology. The side surface includes a laser light irradiation region and a cleavage region. The support member that supports the optical fiber has a surface that is joined to the side surface. By joining this surface to the side surface, the optical fiber is optically connected to the input/output portion of the optical waveguide.

### SUMMARY OF THE INVENTION

An optical connection structure according to the present disclosure includes an optical element including a substrate, and a first optical waveguide formed on the substrate and extending in a first direction; and an optical fiber including a second optical waveguide extending in the first direction. The optical element has a connecting surface intersecting the first direction. The connecting surface includes, in a plan view of the substrate, a first recess recessed in the first direction, and a second recess further recessed in the first direction inside the first recess. The optical fiber is inserted into the first recess, and is connected to the optical element. The second optical waveguide is optically connected to the first optical waveguide in the second recess.

### BRIEF DESCRIPTION OF THE DRAWINGS

FIG. 1 is a side view schematically showing an optical module according to an embodiment.

FIG. 2 is a cross-sectional view showing an optical connection structure according to the embodiment.

FIG. 3 is a cross-sectional view showing the optical connection structure according to the embodiment.

FIG. 4 is a view schematically showing a manufacturing process of an optical element according to the embodiment.

FIG. 5 is a plan view and a cross-sectional view showing a continuation of the manufacturing process of the optical element in FIG. 4.

FIG. 6 is a plan view showing a continuation of the manufacturing process of the optical element in FIG. 5.

FIG. 7 is a cross-sectional view showing a continuation of the manufacturing process of the optical element in FIG. 6.

FIG. 8 is a cross-sectional view showing an example of a support base for an optical fiber according to the embodiment.

FIG. 9 is a perspective view and a cross-sectional view showing a modification example of the support base for the optical fiber according to the embodiment.

FIG. 10 is a cross-sectional view showing an optical connection structure according to a comparative example.

### DETAILED DESCRIPTION

An optical waveguide in which an optical fiber is optically connected to an optical element, such as the self-written waveguide described above, is formed by irradiation with laser light. However, there are cases where a space between the optical fiber and the optical element cannot be appropriately irradiated with the laser light, and in such cases, it may be difficult to form the optical waveguide. Therefore, being able to easily form the optical waveguide and optically connect the optical fiber to the optical element in a simple manner is required.

An object of the present disclosure is to provide an optical connection structure, an optical module, and a method for manufacturing an optical module capable of optically connecting an optical fiber to an optical element in a simple manner.

According to the present disclosure, the optical fiber can be optically connected to the optical element in a simple manner.

### Description of Embodiment of Present Invention

First, the contents of embodiments of the present disclosure will be listed and described. (1) An optical connection structure according to one embodiment includes an optical element including a substrate, and a first optical waveguide formed on the substrate and extending in a first direction; and an optical fiber including a second optical waveguide extending in the first direction. The optical element has a connecting surface intersecting the first direction. The connecting surface includes, in a plan view of the substrate, a first recess recessed in the first direction, and a second recess further recessed in the first direction inside the first recess. The optical fiber is inserted into the first recess, and is connected to the optical element. The second optical waveguide is optically connected to the first optical waveguide in the second recess.

(5) An optical module according to one embodiment includes the optical connection structure described above.

(6) A method for manufacturing an optical module according to one embodiment is a method for manufacturing an optical module including the optical connection structure described above. The method for manufacturing an optical module includes a step of forming the first recess on the connecting surface, the first recess being recessed in the first direction in a plan view of the substrate; and a step of forming the second recess further recessed in the first direction inside the first recess.

The optical connection structure, the optical module, and the method for manufacturing an optical module include the optical element including the substrate and the first optical waveguide, and the optical fiber including the second optical waveguide. The optical element has the connecting surface to which the optical fiber is connected. In a plan view of the substrate, the connecting surface includes the first recess recessed in the first direction in which the first optical waveguide extends, and the second recess further recessed in the first direction from the first recess. The optical fiber is inserted into the first recess, and the second optical waveguide of the optical fiber is optically connected to the first optical waveguide of the optical element in the second recess. By forming the first recess and the second recess, the second recess can be appropriately irradiated with laser light in a state where the optical fiber is inserted into the first recess. Therefore, the second optical waveguide of the optical fiber can be optically connected to the first optical waveguide of the optical element in a simple manner by appropriately performing irradiation with the laser light.

(2) In the above (1), the first optical waveguide may have a first end face facing the second recess, and the second optical waveguide may have a second end face facing the second recess. The second recess may include a resin waveguide that optically connects the second end face to the first end face. In this case, the second optical waveguide of the optical fiber can be connected to the first optical waveguide via the resin waveguide in a simple manner.

(3) In the above (1) or (2), the first recess may have a length larger than a width of the optical fiber in a plan view of the substrate. In this case, in a plan view of the substrate, the optical fiber can be inserted into the first recess. Therefore, the optical connection of the second optical waveguide of the optical fiber to the first optical waveguide can be simplified.

(4) In any one of the above (1) to (3), the second recess may have a length smaller than a width of the optical fiber in a plan view of the substrate. In this case, in a plan view of the substrate, the optical fiber can be prevented from being inserted into the second recess. Therefore, the second recess can be more appropriately irradiated with the laser light, so that the optical connection of the optical fiber to the optical element can be simplified.

### Details of Embodiment of Present Disclosure

Specific examples of an optical connection structure, an optical module, and a method for manufacturing an optical module according to an embodiment of the present disclosure will be described below with reference to the drawings. Note that, it is intended that the present invention is not limited to the following examples and includes all modifications within the scope of the claims and equivalents to the claims. In the description of the drawings, the same or corresponding elements are denoted by the same reference signs, and duplicate descriptions will be omitted as appropriate. The drawings may be depicted partially in a simplified or exaggerated manner for ease of understanding, and dimensional ratios and the like are not limited to those shown in the drawings.

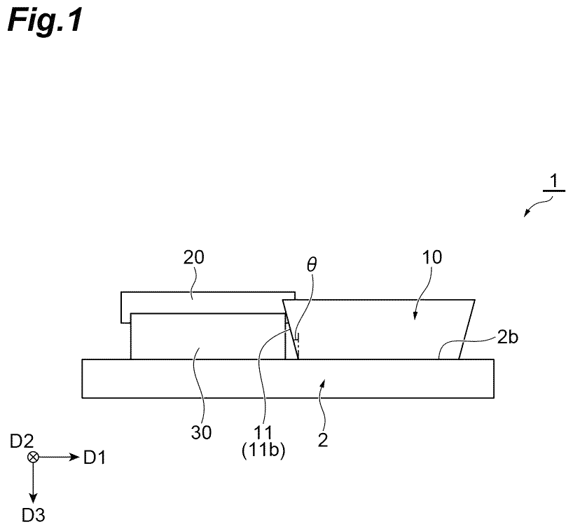

FIG. 1 is a side view showing an optical module 1 according to the present embodiment. For example, the optical module 1 includes a base 2, an optical element 10, and an optical fiber 20. The base 2 has a mounting surface 2b extending in both a first direction D1 and a second direction D2 intersecting the first direction D1. The base 2 has a thickness in a third direction D3 intersecting both the first direction D1 and the second direction D2. The base 2 is made of, for example, copper-tungsten (CuW) or copper-molybdenum (CuMo). The base 2 may be made of ceramic.

For example, the optical element 10 and the optical fiber 20 are located above the base 2. The optical element 10 and the optical fiber 20 are arranged along the first direction D1. The optical module 1 includes a support base 30 that supports the optical fiber 20. Hereinafter, a direction in which the optical fiber 20 is provided when viewed from the support base 30 may be referred to as the top, upper side, or upward, and a direction in which the support base 30 is provided when viewed from the optical fiber 20 may be referred to as the bottom, lower side, or downward. The state of an object when viewed from the top, upper side, or above may be referred to as a plan view. However, these directions and terms are only for convenience of description, and do not limit the disposition positions, directions, and the like of objects.

The support base 30 and the optical element 10 are mounted on the mounting surface 2b of the base 2. The support base 30 and the optical element 10 are arranged along the first direction D1. The support base 30 will be described in detail later. The optical element 10 is, for example, a silicon photonics (SiPh) chip manufactured by SiPh technology. An optical axis of the optical fiber 20 extends along the first direction D1. The optical module 1 may include a package that accommodates the optical element 10 and the optical fiber 20, and an optical input/output portion that performs the input and output of optical signals between the optical fiber 20 and the outside of the optical module 1. Hereinafter, a direction in which the optical element 10 is provided when viewed from the optical fiber 20 may be referred to as the front, front side, or forward, and a direction in which the optical fiber 20 is provided when viewed from the optical element 10 may be referred to as the rear, rear side, or rearward. Note that, these directions and terms are only for convenience of description, and do not limit the disposition positions, directions, and the like of objects.

The optical element 10 has a connecting surface 11 intersecting the first direction D1. The connecting surface 11 is a surface to which the optical fiber 20 is connected. The connecting surface 11 is inclined with respect to the third direction D3 to become further separated from the support base 30 as the connecting surface 11 approaches the mounting surface 2b. Namely, the connecting surface 11 is inclined with respect to the third direction D3 to approach the optical fiber 20 as the connecting surface 11 extends upward. An inclination angle θ of the connecting surface 11 with respect to the third direction D3 is, for example, 0° or more and 10° or less. For example, when viewed along the second direction D2, a part of the connecting surface 11 overlaps a part of the optical fiber 20. For example, the connecting surface 11 includes a facing surface 11b facing the support base 30 along the first direction D1.

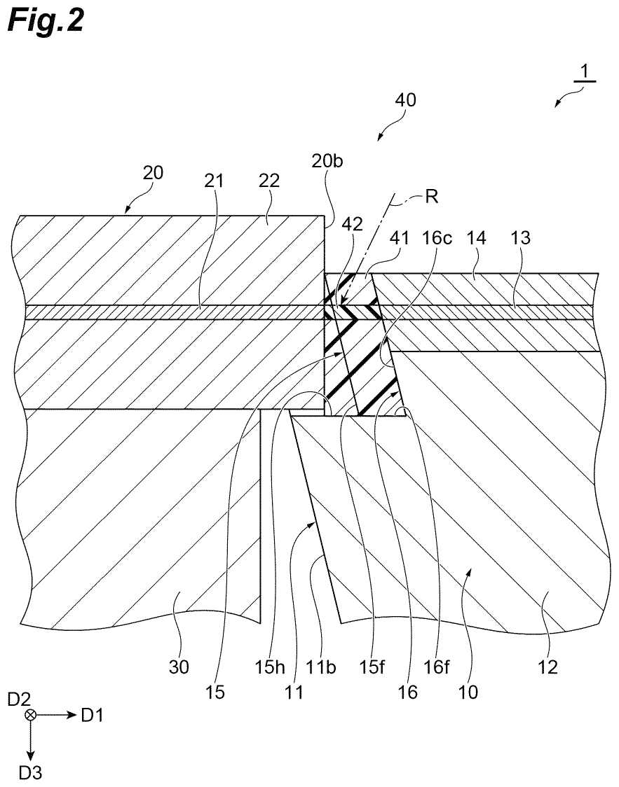

FIG. 2 is a cross-sectional view of an optical connection structure 40 taken along a plane extending in both the first direction D1 and the third direction D3. The optical connection structure 40 according to the present embodiment is a structure in which the optical fiber 20 is connected to the optical element 10. As shown in FIG. 2, the optical element 10 includes, for example, a substrate 12; a first optical waveguide 13 located above the substrate 12; and a cladding 14 surrounding the first optical waveguide 13 above the substrate 12. The first optical waveguide 13 is formed above the substrate 12. The first optical waveguide 13 propagates an optical signal. The first optical waveguide 13 extends along the first direction D1. The optical fiber 20 includes a second optical waveguide 21 extending along the first direction D1. The second optical waveguide 21 is a core that propagates an optical signal, and the optical fiber 20 includes a cladding 22 surrounding the second optical waveguide 21. For example, the optical fiber 20 is disposed such that the second optical waveguide 21 is located on an extension line of the first optical waveguide 13 of the optical element 10.

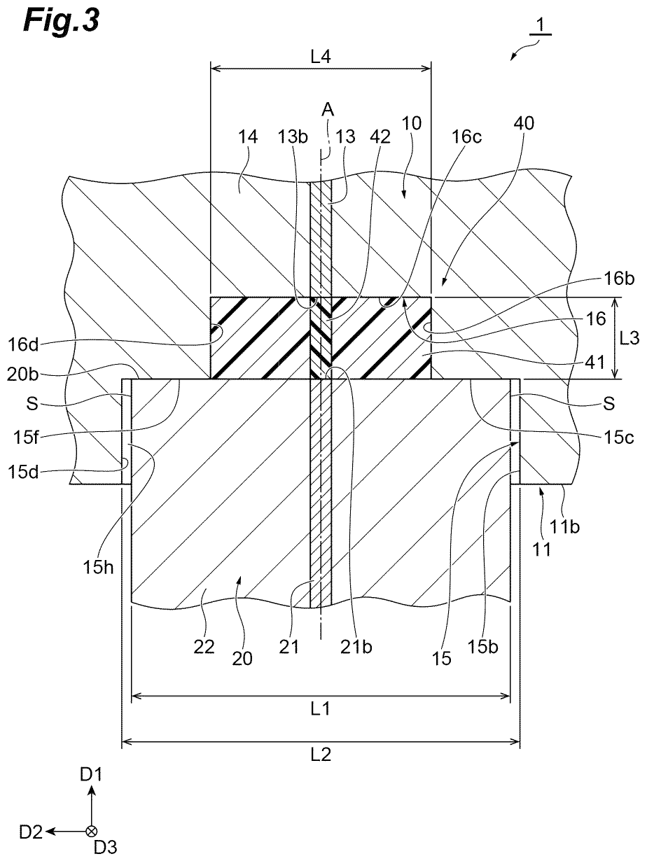

FIG. 3 is a cross-sectional view of the optical connection structure 40 taken along a plane extending in both the first direction D1 and the second direction D2. As shown in FIGS. 2 and 3, the connecting surface 11 of the optical element 10 includes a first recess 15 recessed forward along the first direction D1 in a plan view of the substrate 12 (when the substrate 12 is viewed along the third direction D3). The first recess 15 is recessed forward in a rectangular shape in a plan view of the substrate 12. For example, the first recess 15 is defined by a first surface 15b, a second surface 15c, a third surface 15d, a fourth surface 15f, and a fifth surface 15h.

The first surface 15b extends from the facing surface 11b of the connecting surface 11 in the first direction D1. The first surface 15b extends, for example, in both the first direction D1 and the third direction D3. As one example, the first surface 15b is a flat surface. The second surface 15c extends in the second direction D2 from an end portion of the first surface 15b opposite to the facing surface 11b. The second surface 15c extends, for example, along the second direction D2 toward the third surface 15d. As one example, the second surface 15c is a flat surface. For example, the second surface 15c is inclined with respect to the third direction D3 to become further separated from the optical fiber 20 as the second surface 15c extends downward. The second surface 15c is a surface facing the optical fiber 20. The third surface 15d extends from the facing surface 11b in the first direction D1. The third surface 15d faces the first surface 15b along the second direction D2. The third surface 15d extends in both the first direction D1 and the third direction D3. As one example, the third surface 15d is a flat surface.

The fourth surface 15f extends in a direction opposite to the second direction D2 from an end portion of the third surface 15d opposite to the facing surface 11b. For example, the fourth surface 15f is formed on an extension line of the second surface 15c in a plan view of the substrate 12. The fourth surface 15f extends along the second direction D2 toward the first surface 15b. As one example, the fourth surface 15f is a flat surface. For example, the fourth surface 15f is inclined with respect to the third direction D3 to become further separated from the optical fiber 20 as the fourth surface 15f extends downward. The fourth surface 15f is a surface facing the optical fiber 20. The fifth surface 15h is located at lower ends of the first surface 15b, the second surface 15c, the third surface 15d, and the fourth surface 15f. The fifth surface 15h extends in both the first direction D1 and the second direction D2. As one example, the fifth surface 15h is a flat surface. The fifth surface 15h is a surface located below the optical fiber 20 in the third direction D3.

The optical fiber 20 is inserted into the first recess 15, and is connected to the optical element 10. For example, the optical fiber 20 abuts against the first recess 15. For example, an end portion of the optical fiber 20 may be attached to the first recess 15 of the optical element 10. More specifically, the optical fiber 20 has an optical fiber end face 20b at an end portion of the optical fiber 20 in the first direction D1. The optical fiber end face 20b is, for example, a plane perpendicular to the first direction D1 in which the optical fiber 20 extends. The optical fiber end face 20b abuts against the second surface 15c and the fourth surface 15f along the first direction D1 above the fifth surface 15h. The second surface 15c and the fourth surface 15f are abutting portions of the first recess 15. The first recess 15 has a length L2 larger than a width L1 of the optical fiber 20 (a length of the optical fiber 20 in the second direction D2) in a plan view of the substrate 12.

In a state where the optical fiber 20 is inserted into the first recess 15, a gap S is formed at least between the optical fiber 20 and the first surface 15b or between the optical fiber 20 and the third surface 15d. FIG. 3 shows an example in which the gaps S are formed both between the optical fiber 20 and the first surface 15b and between the optical fiber 20 and the third surface 15d. The width L1 of the optical fiber 20 corresponds to, for example, the diameter of the optical fiber 20. As one example, the width L1 of the optical fiber 20 is 125 μm, and the length L2 of the first recess 15 in the second direction D2 is 135 μm.

The connecting surface 11 of the optical element 10 includes a second recess 16 further recessed forward along the first direction DI inside the first recess 15. The first recess 15 and the second recess 16 are formed by etching. The second recess 16 is recessed forward in a rectangular shape in a plan view of the substrate 12. For example, in a plan view of the substrate 12, the first recess 15 and the second recess 16 are symmetrical with respect to a reference line A extending in the first direction D1 along the first optical waveguide 13. The reference line A is, for example, a center line of the first optical waveguide 13. The second recess 16 is defined by a sixth surface 16b, a seventh surface 16c, an eighth surface 16d, and a ninth surface 16f.

The sixth surface 16b extends forward from the first recess 15 (the second surface 15c) along the first direction D1. The sixth surface 16b extends, for example, in both the first direction D1 and the third direction D3. As one example, the sixth surface 16b is a flat surface. The seventh surface 16c extends from an end portion of the sixth surface 16b opposite to the first recess 15 toward the eighth surface 16d along the second direction D2. As one example, the seventh surface 16c is a flat surface. For example, the seventh surface 16c is inclined with respect to the third direction D3 to become further separated from the optical fiber 20 as the seventh surface 16c extends downward. The seventh surface 16c is a surface facing the optical fiber 20.

The eighth surface 16d faces the sixth surface 16b along the second direction D2. The eighth surface 16d extends forward from the first recess 15 along the first direction D1. The eighth surface 16d extends in both the first direction D1 and the third direction D3. As one example, the eighth surface 16d is a flat surface. The ninth surface 16f is located at lower ends of the sixth surface 16b, the seventh surface 16c, and the eighth surface 16d. The ninth surface 16f extends in both the first direction D1 and the second direction D2. As one example, the ninth surface 16f is a flat surface.

In the second recess 16, the second optical waveguide 21 of the optical fiber 20 is optically connected to the first optical waveguide 13 of the optical element 10. The optical connection structure 40 includes a resin layer 41 with which the second recess 16 is filled, and a resin waveguide 42 formed inside the resin layer 41. The resin layer 41 is formed inside the second recess 16 to cover the resin waveguide 42. Namely, the resin waveguide 42 is encapsulated in the resin layer 41.

The resin waveguide 42 functions as a core through which an optical signal passes, and the resin layer 41 functions as a cladding located around the resin waveguide 42. For example, the resin layer 41 is formed in the second recess 16. However, the resin layer 41 may be formed in the first recess 15 (for example, the gaps S). In this case, the resin layer 41 formed by filling the first recess 15 with resin can be used as an adhesive for fixing a tip of the optical fiber 20 to the optical element 10. Note that, the type of the resin layer 41 formed in the first recess 15 may be different from the type of the resin layer 41 formed in the second recess 16.

In a plan view of the substrate 12, a length L3 of the second recess 16 in the first direction D1 (a length of the sixth surface 16b in the first direction D1 and a length of the eighth surface 16d in the first direction D1) is, for example, 300 μm or less. As one example, the length L3 is 100 μm. The second recess 16 has a length L4 smaller than the width L1 of the optical fiber 20 in a plan view of the substrate 12. For example, the length L4 is larger than a length of the first optical waveguide 13 in the second direction D2, is larger than a length of the second optical waveguide 21 in the second direction D2, and is smaller than the width L1 of the optical fiber 20.

The first optical waveguide 13 has a first end face 13b facing the second recess 16. The second optical waveguide 21 has a second end face 21b facing the second recess 16. The first end face 13b and the second end face 21b face each other along the first direction D1. The first end face 13b may reach the second recess 16 (the seventh surface 16c) in the first direction D1, or may be separated from the second recess 16. The second recess 16 includes the resin waveguide 42 that optically connects the second end face 21b to the first end face 13b. The resin waveguide 42 is a 3D waveguide formed by irradiating the resin layer 41 with laser light R. The resin waveguide 42 is formed by irradiating the resin layer 41 with the laser light R from above. The second end face 21b may be on the same plane as the optical fiber end face 20b.

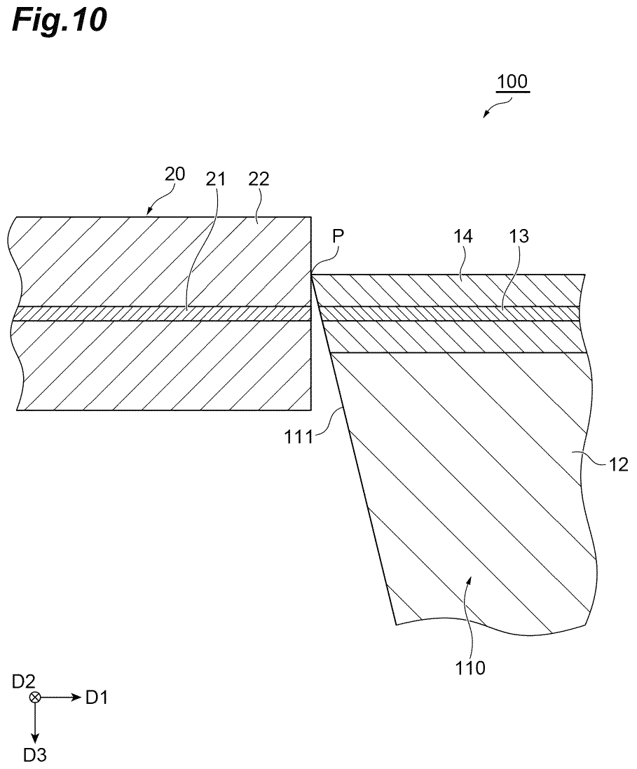

In the related art, there are cases where a space between the optical fiber and the optical element cannot be appropriately irradiated with laser light. Note that, FIG. 10 is a cross-sectional view showing an optical connection structure 100 according to a comparative example that does not include the first recess 15 and the second recess 16. In FIG. 10, the illustration of the support base 30 is omitted. The optical connection structure 100 differs from the optical connection structure 40 described above in that an optical element 110 does not include the first recess 15 and the second recess 16, and is the same in the other respects as the optical connection structure 40.

The optical element 110 has a connecting surface 111 to which the optical fiber 20 is connected, and the connecting surface 111 is inclined with respect to the third direction D3 to become further separated from the optical fiber end face 20b of the optical fiber 20 as the connecting surface 111 extends downward. In this case, an abutting point P of the optical fiber 20 against the optical element 110 is located above the first optical waveguide 13 and the second optical waveguide 21. The state where the connecting surface 111 is inclined as shown in FIG. 10 is also referred to as a reverse taper. Namely, as the abutting point P approaches the mounting surface 2b along the connecting surface 111, the distance between the point and the optical fiber end face 20b in the first direction D1 gradually increases. Therefore, there are cases where a space between the first optical waveguide 13 and the second optical waveguide 21 cannot be irradiated with the laser light R, and it may be difficult to form the resin waveguide 42 between the first optical waveguide 13 and the second optical waveguide 21.

On the other hand, in the optical connection structure 40 according to the present embodiment, as shown in FIGS. 2 and 3, the optical element 10 includes the first recess 15 and the second recess 16. The optical fiber 20 is abutted against the first recess 15, and the second recess 16 located deeper than the first recess 15 is filled with the resin layer 41. Therefore, the space between the first optical waveguide 13 and the second optical waveguide 21 can be easily irradiated with the laser light R, and the resin waveguide 42 can be easily formed between the first optical waveguide 13 and the second optical waveguide 21.

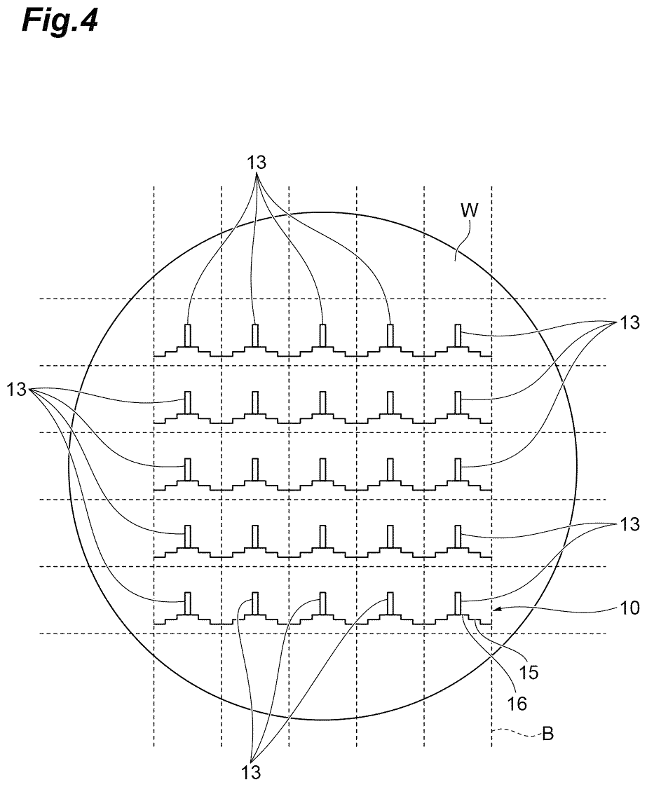

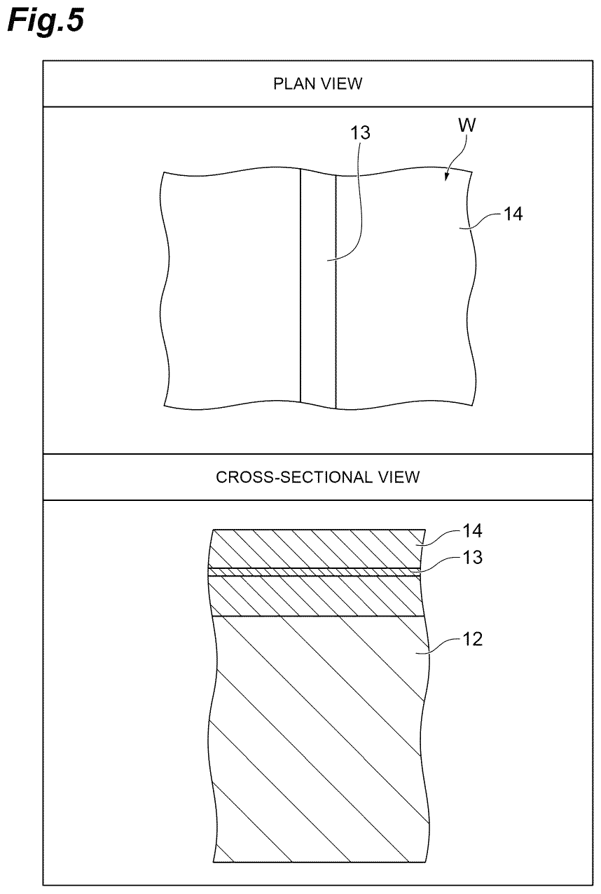

Next, an example of a method for manufacturing an optical module according to the present embodiment will be described. First, a method for manufacturing the optical element 10 will be described. First, as shown in FIG. 4, a wafer W serving as a base for the optical element 10 is prepared (a step of preparing a wafer). Then, as shown in FIGS. 4 and 5, the first optical waveguides 13 are formed on the wafer W in a number corresponding to the number of the optical elements 10 (a step of forming first optical waveguides). FIG. 4 shows an example in which 25 (5×5) first optical waveguides 13 are formed on one wafer W. Note that, in the optical element 10, an optical circuit such as an optical waveguide other than the first optical waveguide 13, an optical demultiplexer, or an optical multiplexer may be formed together with the first optical waveguide 13. Since the first recess 15 and the second recess 16 are formed by etching to be described later, the first recess 15 and the second recess 16 are not included in the cross-sectional view of FIG. 5. However, since FIG. 4 shows the positions where the first recesses 15 and the second recesses 16 are formed, the shape after etching is illustrated.

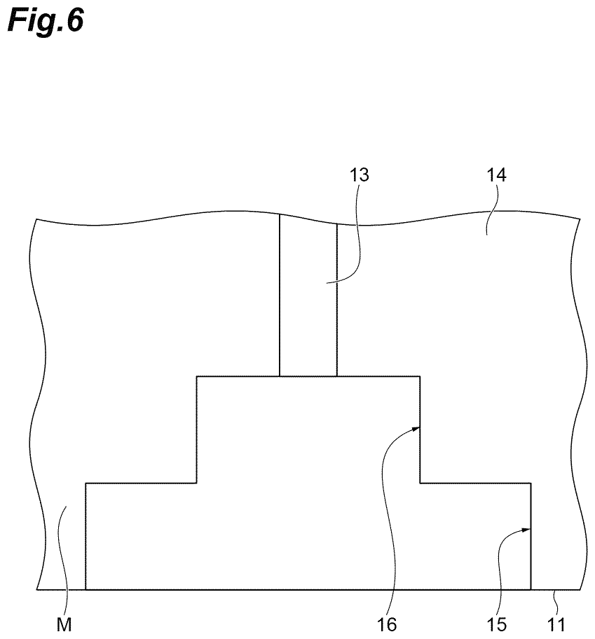

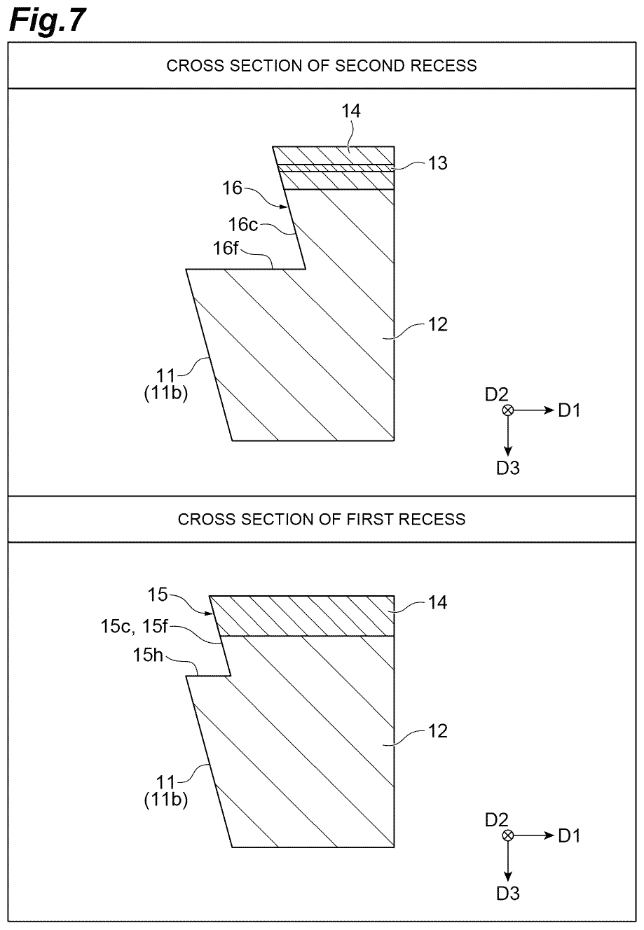

After the first optical waveguides 13 are formed, patterning is performed with a mask M placed on an upper surface of the wafer W, and etching is performed with regions where it is planned to form the first recesses 15 and the second recesses 16 exposed (refer to FIG. 6). By this etching, the first recesses 15 are formed and the second recesses 16 are formed. At this time, as shown in FIG. 7, the first recesses 15, each having the second surface 15c and the fourth surface 15f inclined with respect to the third direction D3 to become further separated from the optical fiber 20 as the second surface 15c and the fourth surface 15f extend downward, and the second recesses 16, each having the seventh surface 16c inclined in a similar manner, are formed on the connecting surface 11 (a step of forming first recesses and a step of forming second recesses). After the first recesses 15 and the second recesses 16 are formed, as shown in FIG. 4, dicing is performed along scribe lines B (a step of performing dicing). Accordingly, a plurality of the optical elements 10 are obtained from the wafer W, and a series of the steps in the method for manufacturing the optical elements 10 are completed.

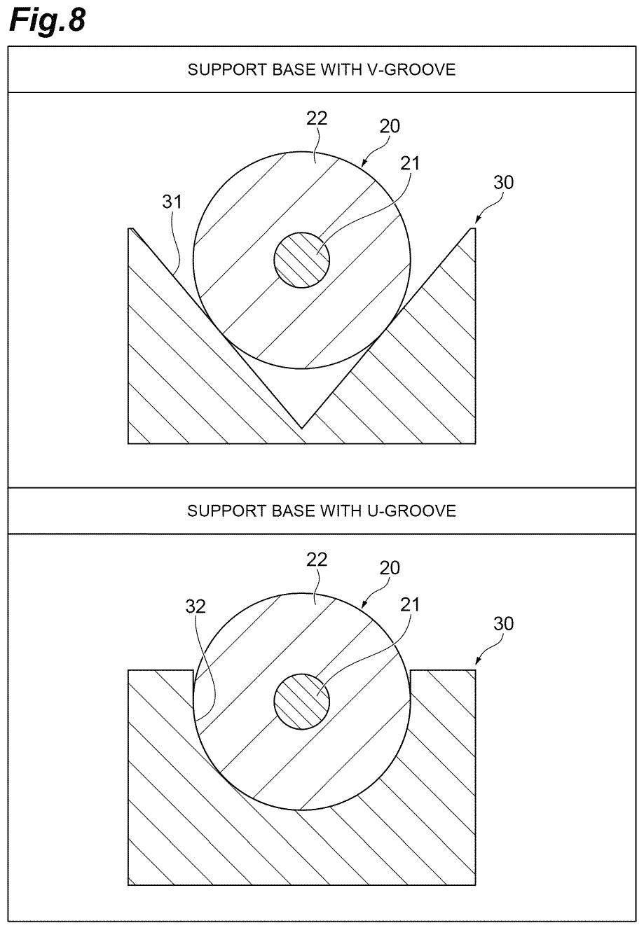

Subsequently, the optical fiber 20 and the support base 30 are prepared (a step of preparing an optical fiber and a support base). FIG. 8 is a cross-sectional view of the optical fiber 20 and the support base 30 when taken along a plane perpendicular to the first direction D1. The support base 30 is a support base for fixing the optical fiber 20. The support base 30 supports the optical fiber 20 such that the optical fiber 20 extends along the first direction D1. The support base 30 includes a V-groove 31 in which the optical fiber 20 is placed, and the optical fiber 20 is fixed to the V-groove 31 by, for example, an adhesive. Note that, instead of the support base 30 including the V-groove 31, the support base 30 including a U-groove 32 may be used.

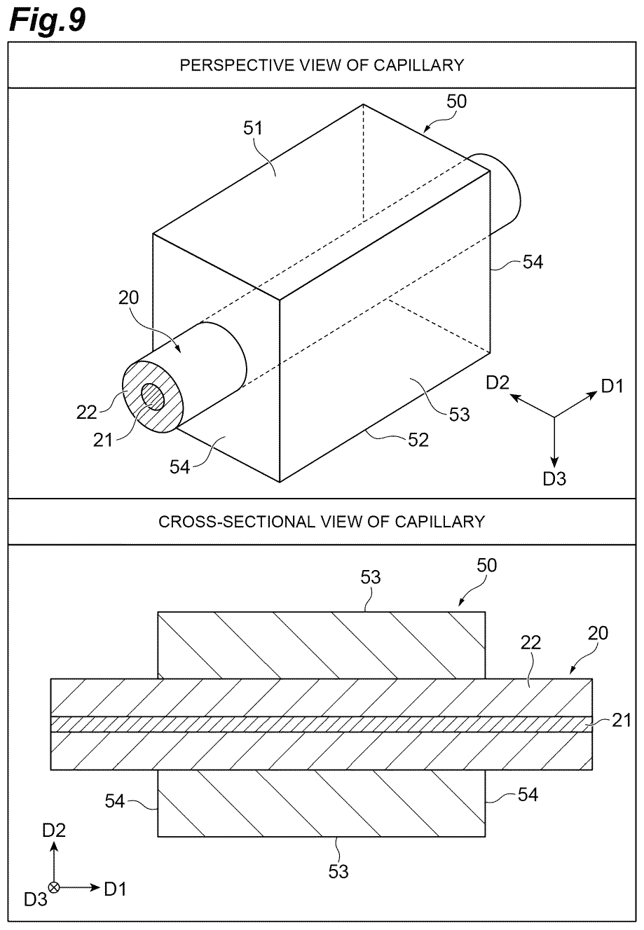

As shown in FIG. 9, instead of the optical fiber 20 and the support base 30, the optical fiber 20 to which a capillary 50 is fixed may be used. The capillary 50 is made of, for example, glass or zirconia. The capillary 50 has, for example, an upper surface 51 and a lower surface 52 extending along both the first direction D1 and the second direction D2; first side surfaces 53 extending along both the first direction D1 and the third direction D3; and second side surfaces 54 extending along both the second direction D2 and the third direction D3. The capillary 50 has a pair of the first side surfaces 53 arranged along the second direction D2, and a pair of the second side surfaces 54 arranged along the first direction D1. The optical fiber 20 penetrates through the capillary 50 along the first direction D1, and the optical fiber 20 protrudes from each of the pair of second side surfaces 54 in the first direction D1. Even when the capillary 50 is used, the optical fiber 20 can be supported such that the optical fiber 20 extends along the first direction D1.

Subsequently, as shown in FIGS. 2 and 3, the end portion of the optical fiber 20 in the first direction D1 is inserted into the first recess 15, and the optical fiber end face 20b of the optical fiber 20 is abutted against the first recess 15 (a step of abutting the optical fiber against the first recess). The second recess 16 is filled with resin to form the resin layer 41 (a step of forming a resin layer). Then, the resin layer 41 is irradiated with the laser light R to form the resin waveguide 42 (a step of forming a resin waveguide). The resin waveguide 42 is formed to extend from the first end face 13b of the first optical waveguide 13 to the second end face 21b of the second optical waveguide 21. The second optical waveguide 21 is optically coupled to the first optical waveguide 13 by the resin waveguide 42. Note that, even when the position of the second end face 21b in the second direction D2 or the third direction D3 is slightly shifted from the position of the first end face 13b, the resin waveguide 42 that is curved can be formed by irradiation with the laser light R, so that a misalignment of the second end face 21b with respect to the first end face 13b can be absorbed. After the resin waveguide 42 is formed as described above, the optical connection structure 40 is completed, and a series of the steps in the method for manufacturing the optical module 1 are completed.

Next, actions and effects obtained from the optical connection structure 40, the optical module 1, and the method for manufacturing an optical module according to the present embodiment will be described in detail. The optical connection structure 40, the optical module 1, and the method for manufacturing an optical module according to the present embodiment include the optical element 10 including the substrate 12 and the first optical waveguide 13, and the optical fiber 20 including the second optical waveguide 21. The optical element 10 has the connecting surface 11 to which the optical fiber 20 is connected. In a plan view of the substrate 12, the connecting surface 11 includes the first recess 15 recessed forward in the first direction D1 in which the first optical waveguide 13 extends, and the second recess 16 further recessed forward in the first direction D1 from the first recess 15. The end portion of the optical fiber 20 is inserted into the first recess 15, and the second optical waveguide 21 of the optical fiber 20 is optically connected to the first optical waveguide 13 in the second recess 16. Therefore, by forming the first recess 15 and the second recess 16, the second recess 16 can be appropriately irradiated with the laser light R in a state where the optical fiber 20 is inserted into the first recess 15. Therefore, the second optical waveguide 21 of the optical fiber 20 can be optically connected to the first optical waveguide 13 of the optical element 10 in a simple manner by appropriately performing irradiation with the laser light R. For example, the end portion of the optical fiber 20 may be attached to the first recess 15 of the optical element 10.

In the present embodiment, the first optical waveguide 13 has the first end face 13b facing the second recess 16, and the second optical waveguide 21 has the second end face 21b facing the second recess 16. The second recess 16 includes the resin waveguide 42 that optically connects the second end face 21b to the first end face 13b. In this case, the second optical waveguide 21 of the optical fiber 20 can be connected to the first optical waveguide 13 via the resin waveguide 42 in a simple manner. The resin waveguide 42 is formed from resin applied in the second recess 16 by irradiation with the laser light R described above such that the resin waveguide 42 is in contact with the first end face 13b and the second end face 21b. The resin other than the resin waveguide 42 forms the resin layer 41.

In the present embodiment, the first recess 15 has the length L2 larger than the width L1 of the optical fiber 20 in a plan view of the substrate 12. In this case, in a plan view of the substrate 12, the end portion of the optical fiber 20 can be inserted into the first recess 15. Therefore, the optical connection of the second optical waveguide 21 of the optical fiber 20 to the first optical waveguide 13 can be simplified. In more detail, by inserting the end portion of the optical fiber 20 into the first recess 15, misalignments between the center of the second end face 21b and the first end face 13b in the second direction D2 and the third direction D3 can be kept within a range where the resin waveguide 42 can be formed by irradiation with the laser light R.

In the present embodiment, the second recess 16 has the length L4 smaller than the width L1 of the optical fiber 20 in a plan view of the substrate 12. In this case, in a plan view of the substrate 12, the optical fiber 20 can be prevented from being inserted into the second recess 16. Therefore, the second recess 16 can be more appropriately irradiated with the laser light R, so that the optical connection of the optical fiber 20 to the optical element 10 can be simplified. In addition, by setting the length L3 of the second recess 16 in the first direction D1 to an appropriate value, a distance between the second end face 21b and the first end face 13b in the first direction D1 can be kept within a range where the resin waveguide 42 can be formed by irradiation with the laser light R.

The embodiments of the optical connection structure, the optical module, and the method for manufacturing an optical module according to the present disclosure have been described above. However, the present invention is not limited to the above-described embodiments, and may be further modified within the scope of the concept described in the claims. Namely, the configuration, shape, size, material, number, and disposition mode of each portion of the optical connection structure and the optical module according to the present disclosure and the contents and order of the steps in the method for manufacturing an optical module are not limited to the above-described embodiments, and can be modified as appropriate.

1. An optical connection structure comprising:
an optical element including a substrate, and a first optical waveguide formed on the substrate and extending in a first direction; and
an optical fiber including a second optical waveguide extending in the first direction,
wherein the optical element has a connecting surface intersecting the first direction,
the connecting surface includes, in a plan view of the substrate, a first recess recessed in the first direction, and a second recess further recessed in the first direction inside the first recess,
the optical fiber is inserted into the first recess, and is connected to the optical element, and
the second optical waveguide is optically connected to the first optical waveguide in the second recess.

2. The optical connection structure according to claim 1,
wherein the first optical waveguide has a first end face facing the second recess,
the second optical waveguide has a second end face facing the second recess, and
the second recess includes a resin waveguide that optically connects the second end face to the first end face.

3. The optical connection structure according to claim 1,
wherein the first recess has a length larger than a width of the optical fiber in a plan view of the substrate.

4. The optical connection structure according to claim 1,
wherein the second recess has a length smaller than a width of the optical fiber in a plan view of the substrate.

5. An optical module comprising:
the optical connection structure according to claim 1.

6. A method for manufacturing an optical module including the optical connection structure according to claim 1, comprising:
a step of forming the first recess on the connecting surface, the first recess being recessed in the first direction in a plan view of the substrate; and
a step of forming the second recess further recessed in the first direction inside the first recess.
